(19) United States
(12) Patent Application Publication
(10) Pub. No.: US 2024/0083279 A1
(43) Pub. Date: Mar. 14, 2024

(54) SYSTEM AND METHOD FOR AUTONOMOUS CHARGING

(71) Applicant: NEW YORK UNIVERSITY, New York, NY (US)

(72) Inventors: Giuseppe Loianno, New York, NY (US); Alessandro Saviolo, Brooklyn, NY (US); Jeffrey Mao, Brooklyn, NY (US); Roshan Balu Thalaivirithan Margabandu Balakrishnan, Brooklyn, NY (US); Vivek Radhakrishnan, Brooklyn, NY (US)

(21) Appl. No.: 18/467,202

(22) Filed: Sep. 14, 2023

Related U.S. Application Data
(60) Provisional application No. 63/375,638, filed on Sep. 14, 2022.

(51) Int. Cl. B60L 53/36; B60L 53/16; B60L 53/18; B64U 10/60; B64U 50/34

(52) U.S. Cl. CPC B60L 53/36; B60L 53/16; B60L 53/18; B64U 10/60; B64U 50/34; B60L 2200/10

(57) ABSTRACT

A system for charging a battery in an aircraft comprises a ground station comprising an electrical connector configured to be connected to a source of power, a charging port comprising a plurality of electrical contacts a surface of the ground station, and at least one magnetic element positioned on the surface of the ground station, a tether configured to be connected at the proximal end to the aircraft, comprising an electrical connector at the proximal end configured to be connected to a battery of a aircraft, at least one tether magnetic element positioned at the distal end, and a tether charging connector positioned at the distal end, configured to electrically connect to the charging port when the at least one tether magnetic element is connected to the at least one ground station magnetic element. A method of charging an aircraft is also disclosed.

### CROSS-REFERENCE TO RELATED APPLICATIONS

This application claims priority to 63/375,638, filed on Sep. 14, 2022, incorporated herein by reference in its entirety.

### STATEMENT REGARDING FEDERALLY SPONSORED RESEARCH OR DEVELOPMENT

This invention was made with government support under 2145277 awarded by the National Science Foundation and D22AP00156 awarded by the Department of Defense. The government has certain rights in the invention.

### BACKGROUND OF THE INVENTION

In recent years, unmanned aerial vehicles (UAVs) like quadrotors have drawn significant attention for several applications including search and rescue, transportation, and inspection due to their simplicity in design, agility, low cost, and ability to hover in place and move in 3D (Emran, et al., Annual Reviews in Control, 2018). Nevertheless, these robots are constrained by limited battery endurance which restrains their applicability in persistent, long-distance missions.

The ideal solution for the autonomous charging problem for quadrotors requires a system that is efficient to reduce power waste and heat generation, portable, so that it may be transported and used in different tasks, universal, so that it is able to charge quadrotors of different frame shapes, sizes, and battery capacities, and robust, such that it guarantees persistent docking performance by accommodating large control and localization errors of the quadrotor.

Various solutions have been proposed for extending the flight time of quadrotors. One such solution is battery expansion and battery replacement (see De Silva, et al., Drones, 2022; Williams, et al., International Conference on Control, Automation and Robotics, 2018; Liu, et al., IEEE Conference on Robotics, Automation and Mechatronics, 2017; Ure, et al., IEEE/ASME Transactions on Mechatronics, 2015; Lee, et al., International Conference on Unmanned Aircraft Systems (ICUAS), 2015; and Michini, et al., Proceedings of the Infotech Aerospace, 2011). Others include wireless charging (see Jawad, et al., Energies, 2022; Junaid, et al., Aerospace Science and Technology, 2016; Choi, et al., International Conference on Control, Automation and Information Sciences, 2016; and Chae, et al., 2015 IEEE International Conference on Advanced Intelligent Mechatronics (AIM), 2015); contact charging (see Jain, et al., IEEE International Conference on Robotics and Automation (ICRA), 2020; Cocchioni, et al., International Conference on Unmanned Aircraft Systems, 2014; Mulgaonkar, et al., 2014; and Song, et al., International Conference on Unmanned Aircraft Systems, 2014); and tethered charging (see Gu, et al., Nuclear Engineering and Technology, 2016; Kiribayashi, et al., IEEE International Symposium on Safety, Security, and Rescue Robotics, 2015; and Wang, et al., IEEE International Conference on Robotics and Automation (ICRA), 2021).

However, these approaches do not meet all the requirements of the ideal autonomous charging system for quadrotors, but trade-off efficiency, portability, universality, and robustness. Therefore, there is a need in the art for a universal, efficient, autonomous charging solution for UAVs.

### SUMMARY OF THE INVENTION

In one aspect, a system for charging a battery in an aircraft comprises a ground station comprising an electrical connector configured to be connected to a source of power, a charging port comprising a plurality of electrical contacts positioned on a surface of the ground station, and at least one ground station magnetic element positioned on the surface of the ground station, a tether having a proximal and distal end, configured to be connected at the proximal end to the aircraft, comprising an electrical connector at the proximal end configured to be connected to a battery of a aircraft, at least one tether magnetic element positioned at the distal end, and a tether charging connector positioned at the distal end, configured to electrically connect to the charging port when the at least one tether magnetic element is connected to the at least one ground station magnetic element.

In one embodiment, the charging port comprises a central conductive element and at least one circular conductive element concentric with the central conductive element. In one embodiment, the at least one circular conductive element comprises two circular conductive elements. In one embodiment, the tether charging connector comprises a plurality of conductive elements arranged in a linear array. In one embodiment, the charging port comprises a central conductive element and K circular conductive elements concentric with the central conductive element, and the tether charging connector comprises a plurality of 2K+1 conductive elements arranged in a linear array.

In one embodiment, the plurality of conductive elements comprise pogo pins. In one embodiment, the tether comprises 20 gauge multi-core wire. In one embodiment, the battery of the aircraft is selected from a lithium ion battery or a lithium polymer battery. In one embodiment, the system further comprises a current sensor configured to detect a current passing through the charging port. In one embodiment, the ground station magnetic element comprises an electromagnet, and wherein the ground station further comprises a relay configured to enable or disable the electromagnet. In one embodiment, the system further comprises a computing device electrically connected to the ground station, configured to control the electromagnet.

In one aspect, a method of charging an aircraft comprises providing an aircraft having a charging tether with a tether electrical connector comprising a tether magnetic element, providing a charging station having a charging port configured to mate with the tether electrical connector and a controllable magnetic element, moving the aircraft into a position such that the tether electrical connector is proximate to the charging port, engaging the controllable magnetic element to attract the tether magnetic element of the tether electrical connector toward the charging port, and when the tether electrical connector is electrically connected to the charging port, disengaging the controllable magnetic element.

In one embodiment, the method further comprises the step of landing and powering down the aircraft after the tether electrical connector is electrically connected to the charging port. In one embodiment, the method further comprises the step of, when a battery of the aircraft is fully charged, moving the aircraft away from the charging station, causing the tether electrical connector to disengage from the charging port. In one embodiment, the method further comprises the step of detecting when the tether electrical connector is electrically connected to the charging port with a sensor connected to a computing device, and disengaging the controllable magnetic element with the computing device. In one embodiment, the controllable magnetic element is disengaged via a relay. In one embodiment, the sensor is a current sensor. In one embodiment, the sensor is a proximity sensor.

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements, and in which:

FIG. 1 is a diagram of an exemplary computing device.

FIG. 2 is a photograph of an exemplary aircraft and charging station.

FIG. 3A-FIG. 3I are sequential images of an exemplary docking and undocking procedure.

FIG. 4 is a photograph of an exemplary charging station.

FIG. 5 is a photograph of exemplary charging connectors.

FIG. 6A is a photograph of exemplary charging connectors.

FIG. 6B are electrical diagrams of exemplary charging connectors.

FIG. 6C is a schematic diagram of an exemplary charging connector.

FIG. 7 is an exemplary system diagram of a tether and a battery.

FIG. 8 is a schematic diagram of an exemplary charging system.

FIG. 9 is a set of graphs of experimental results.

FIG. 10 is a graph of experimental results.

### DETAILED DESCRIPTION

It is to be understood that the figures and descriptions of the present invention have been simplified to illustrate elements that are relevant for a clear understanding of the present invention, while eliminating, for the purpose of clarity, many other elements found in related systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, exemplary methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, and ±0.1% from the specified value, as such variations are appropriate.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, 6 and any whole and partial increments therebetween. This applies regardless of the breadth of the range.

In some aspects of the present invention, software executing the instructions provided herein may be stored on a non-transitory computer-readable medium, wherein the software performs some or all of the steps of the present invention when executed on a processor.

Aspects of the invention relate to algorithms executed in computer software. Though certain embodiments may be described as written in particular programming languages, or executed on particular operating systems or computing platforms, it is understood that the system and method of the present invention is not limited to any particular computing language, platform, or combination thereof. Software executing the algorithms described herein may be written in any programming language known in the art, compiled or interpreted, including but not limited to C, C++, C#, Objective-C, Java, JavaScript, MATLAB, Python, PHP, Perl, Ruby, or Visual Basic. It is further understood that elements of the present invention may be executed on any acceptable computing platform, including but not limited to a server, a cloud instance, a workstation, a thin client, a mobile device, an embedded microcontroller, a television, or any other suitable computing device known in the art.

Parts of this invention are described as software running on a computing device. Though software described herein may be disclosed as operating on one particular computing device (e.g. a dedicated server or a workstation), it is understood in the art that software is intrinsically portable and that most software running on a dedicated server may also be run, for the purposes of the present invention, on any of a wide range of devices including desktop or mobile devices, laptops, tablets, smartphones, watches, wearable electronics or other wireless digital/cellular phones, televisions, cloud instances, embedded microcontrollers, thin client devices, or any other suitable computing device known in the art.

Similarly, parts of this invention are described as communicating over a variety of wireless or wired computer networks. For the purposes of this invention, the words “network”, “networked”, and “networking” are understood to encompass wired Ethernet, fiber optic connections, wireless connections including any of the various 802.11 standards, cellular WAN infrastructures such as 3G, 4G/LTE, or 5G networks, Bluetooth®, Bluetooth® Low Energy (BLE) or Zigbee® communication links, or any other method by which one electronic device is capable of communicating with another. In some embodiments, elements of the networked portion of the invention may be implemented over a Virtual Private Network (VPN).

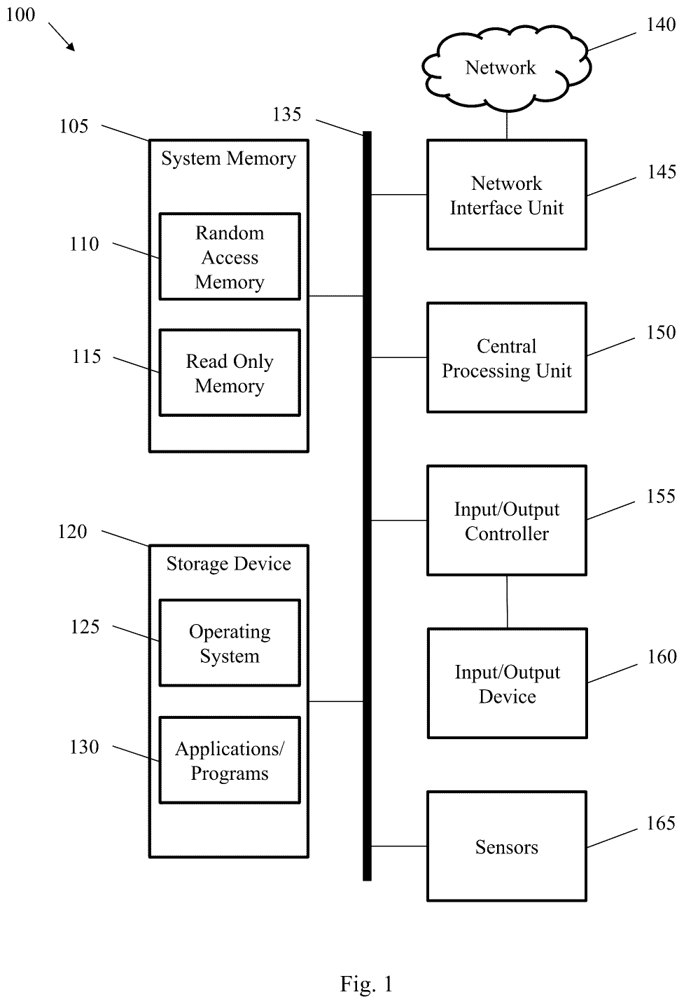

FIG. 1 and the following discussion are intended to provide a brief, general description of a suitable computing environment in which the invention may be implemented. While the invention is described above in the general context of program modules that execute in conjunction with an application program that runs on an operating system on a computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

FIG. 1 depicts an illustrative computer architecture for a computer 100 for practicing the various embodiments of the invention. The computer architecture shown in FIG. 1 illustrates a conventional personal computer, including a central processing unit 150 (“CPU”), a system memory 105, including a random access memory 110 (“RAM”) and a read-only memory (“ROM”) 115, and a system bus 135 that couples the system memory 105 to the CPU 150. A basic input/output system containing the basic routines that help to transfer information between elements within the computer, such as during startup, is stored in the ROM 115. The computer 100 further includes a storage device 120 for storing an operating system 125, application/program 130, and data.

The storage device 120 is connected to the CPU 150 through a storage controller (not shown) connected to the bus 135. The storage device 120 and its associated computer-readable media provide non-volatile storage for the computer 100. Although the description of computer-readable media contained herein refers to a storage device, such as a hard disk or CD-ROM drive, it should be appreciated by those skilled in the art that computer-readable media can be any available media that can be accessed by the computer 100.

By way of example, and not to be limiting, computer-readable media may comprise computer storage media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

According to various embodiments of the invention, the computer 100 may operate in a networked environment using logical connections to remote computers through a network 140, such as TCP/IP network such as the Internet or an intranet. The computer 100 may connect to the network 140 through a network interface unit 145 connected to the bus 135. It should be appreciated that the network interface unit 145 may also be utilized to connect to other types of networks and remote computer systems.

The computer 100 may also include an input/output controller 155 for receiving and processing input from a number of input/output devices 160, including a keyboard, a mouse, a touchscreen, a camera, a microphone, a controller, a joystick, or other type of input device. Similarly, the input/output controller 155 may provide output to a display screen, a printer, a speaker, or other type of output device. The computer 100 can connect to the input/output device 160 via a wired connection including, but not limited to, fiber optic, Ethernet, or copper wire or wireless means including, but not limited to, Wi-Fi, Bluetooth, Near-Field Communication (NFC), infrared, or other suitable wired or wireless connections.

As mentioned briefly above, a number of program modules and data files may be stored in the storage device 120 and/or RAM 110 of the computer 100, including an operating system 125 suitable for controlling the operation of a networked computer. The storage device 120 and RAM 110 may also store one or more applications/programs 130. In particular, the storage device 120 and RAM 110 may store an application/program 130 for providing a variety of functionalities to a user. For instance, the application/program 130 may comprise many types of programs such as a word processing application, a spreadsheet application, a desktop publishing application, a database application, a gaming application, internet browsing application, electronic mail application, messaging application, and the like. According to an embodiment of the present invention, the application/program 130 comprises a multiple functionality software application for providing word processing functionality, slide presentation functionality, spreadsheet functionality, database functionality and the like.

The computer 100 in some embodiments can include a variety of sensors 165 for monitoring the environment surrounding and the environment internal to the computer 100. These sensors 165 can include a Global Positioning System (GPS) sensor, a photosensitive sensor, a gyroscope, a magnetometer, thermometer, a proximity sensor, an accelerometer, a microphone, biometric sensor, barometer, humidity sensor, radiation sensor, or any other suitable sensor.

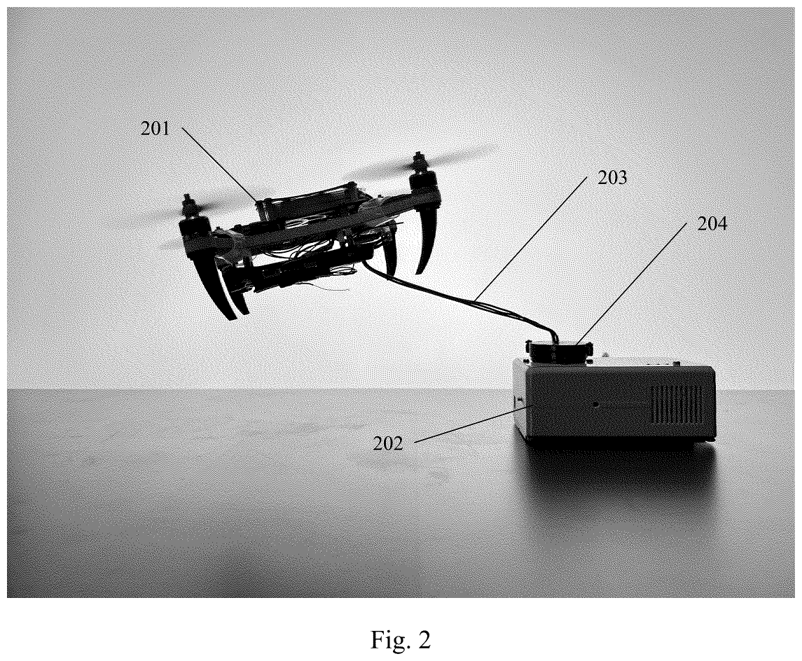

Disclosed herein in various embodiments is an autonomous charging solution for aerial vehicles, including but not limited to quadrotors. Such aerial vehicles may be referred to herein as unmanned aerial vehicles (UAVs). Although certain embodiments and examples may be presented herein in the context of UAVs, quadrotors, or particular vehicles, it is understood that the systems and methods disclosed herein may be applied equally to aerial vehicles, water vehicles, land-based vehicles, unmanned vehicles, piloted vehicles, any vehicle capable of standing still when active, or any other suitable battery-powered vehicle that is designed to meet the requirements of the ideal autonomous charging system. One embodiment of the disclosed system, shown in FIG. 2, comprises a compact ground station 202, and a flexible charging tether 203, to connect the ground station 202 to the UAV 201.

The charging is performed through a pair of connectors 204, which may in some embodiments be circular magnetic connectors that establish a precise, orientation-agnostic connection between the tether 203 and the station 202. By leveraging direct contact charging, the disclosed system ensures a low impedance electrical connection, and thus high electrical efficiency, while charging.

The ground station may in some embodiments comprise a magnet, which may in some embodiments be a switchable magnet, for example an electromagnet (EM), to strengthen the magnetic field generated by one or more magnets positioned within or on the connectors. Where an EM is used, the EM may be configured such that it is only active during docking and disabled during charging and un-docking. Such a configuration increases the probability of a correct contact when approaching the ground station, but also an easy and smooth detachment when the charging operation is completed.

Consequently, by leveraging the circular magnetic connectors and the EM, the disclosed system is robust to control and localization errors (see Saviolo, et al., IEEE Robotics and Automation Letters, 2022; Saviolo, et al., arXiv, 2022). The charging tether may be configured as an add-on to an existing onboard battery, thus requiring minimal modifications for the UAV, and enabling the disclosed system to charge quadrotors of different frame shapes and sizes.

In some embodiments, the ground station 202 comprises a parallel balance charger, enabling the disclosed system to target any lithium polymer (LiPo) battery size. Although embodiments disclosed herein may be presented in view of certain battery technologies (for example LiPo) it is understood that the disclosed systems and methods apply equally to other rechargeable batteries and rechargeable power storage technologies, including but not limited to nickel cadmium (NiCd), Nickel Metal Hydride (NiMH), Lead Acid, Zinc Air, supercapacitors, and the like.

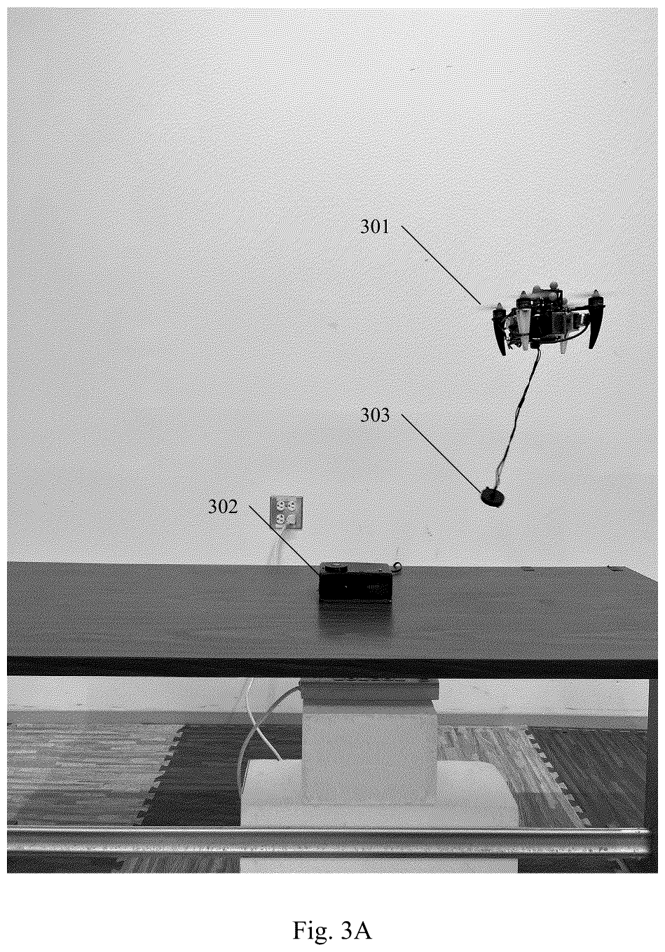

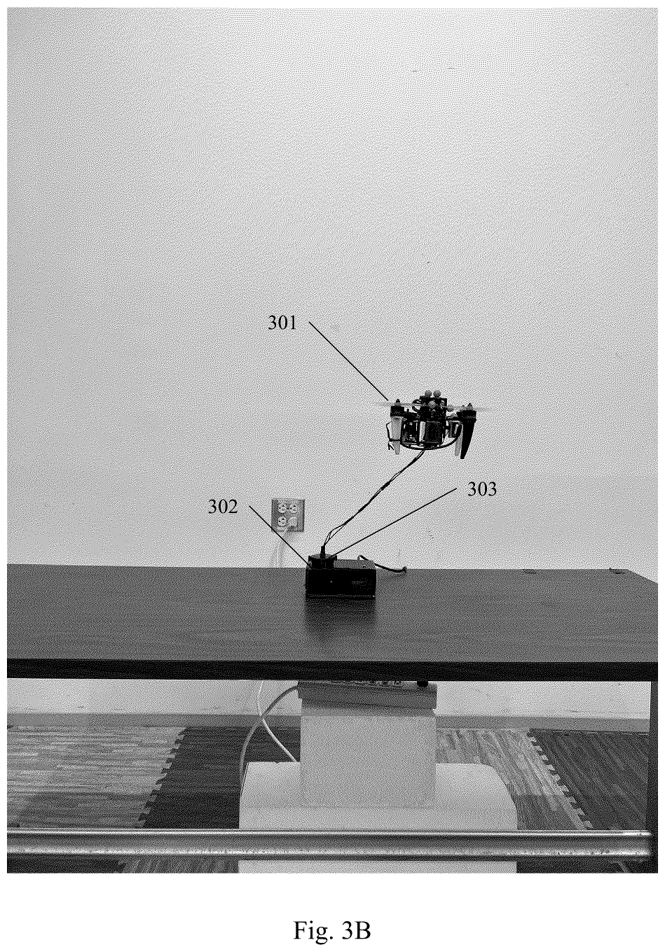

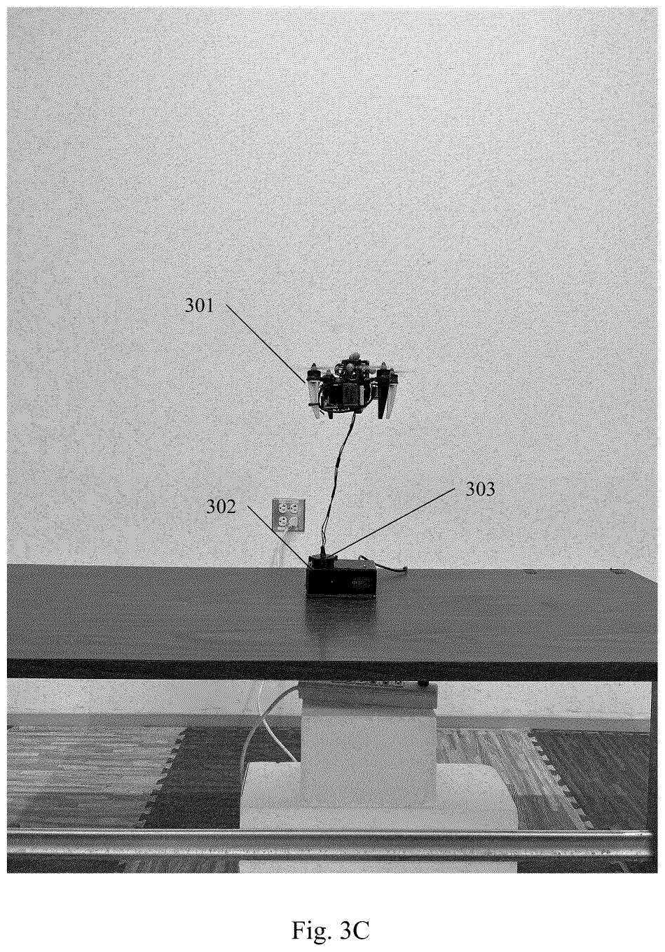

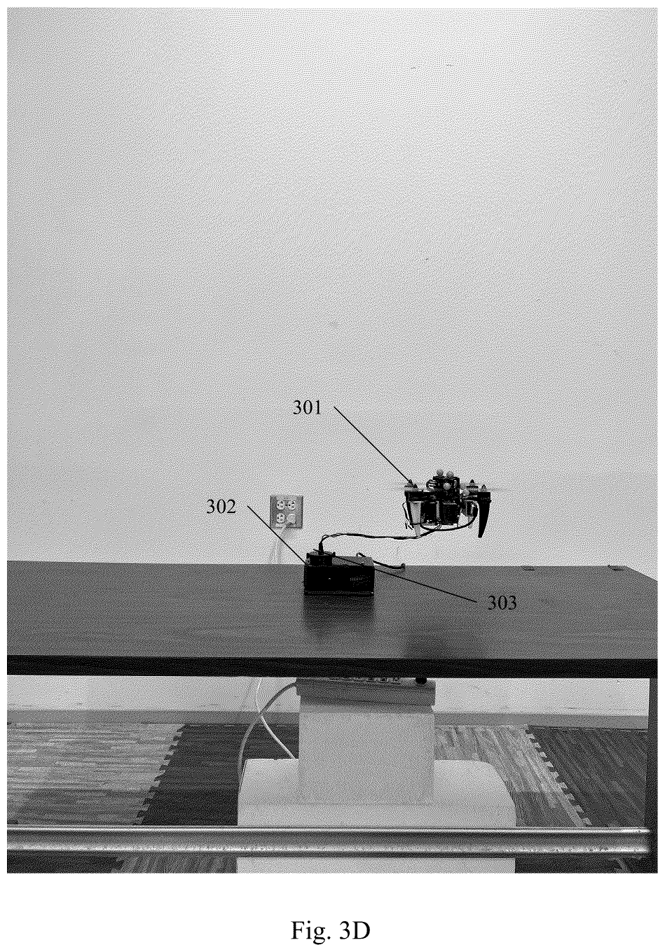

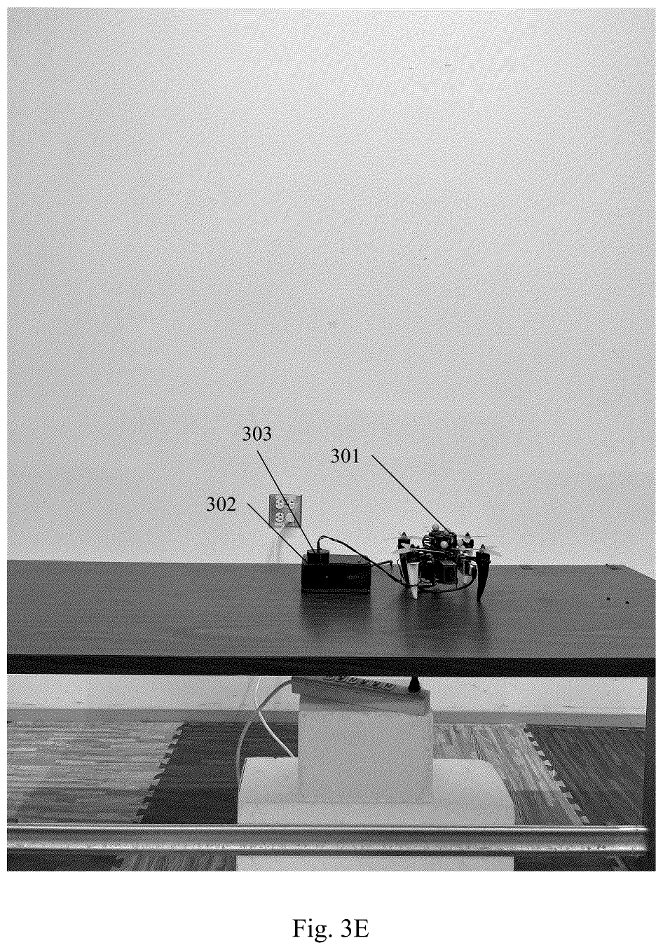

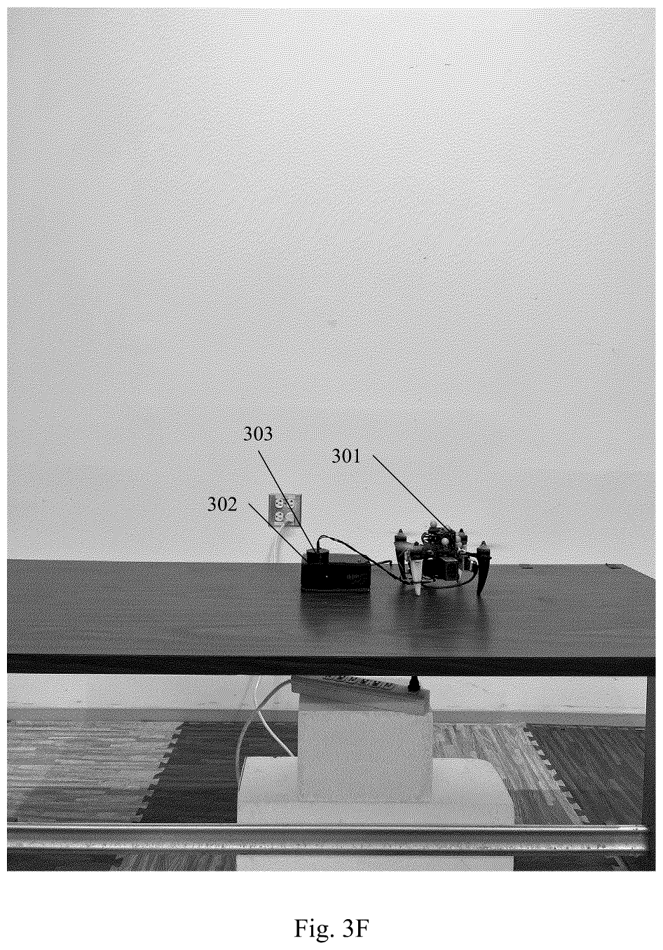

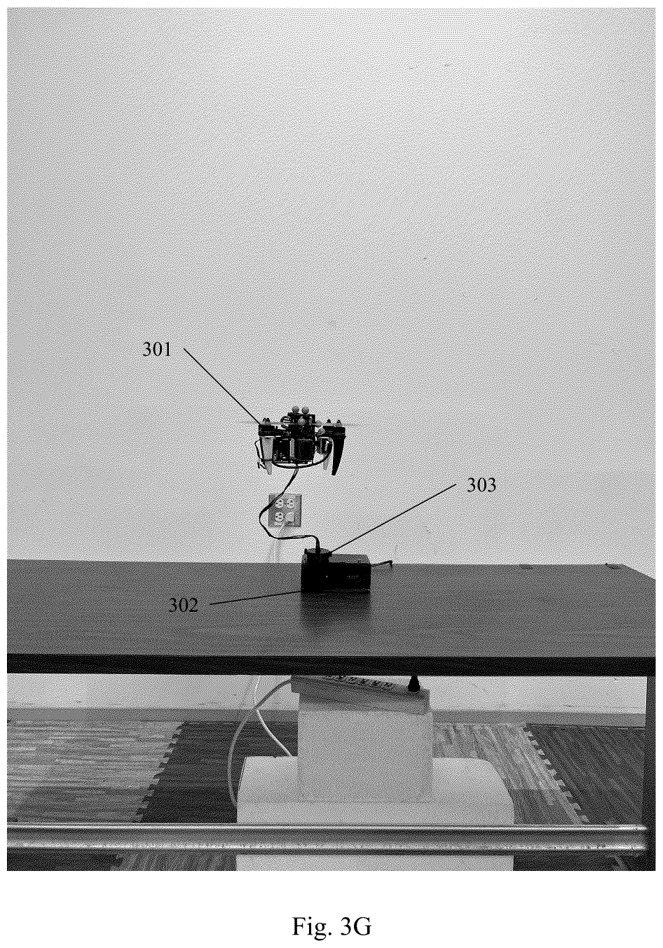

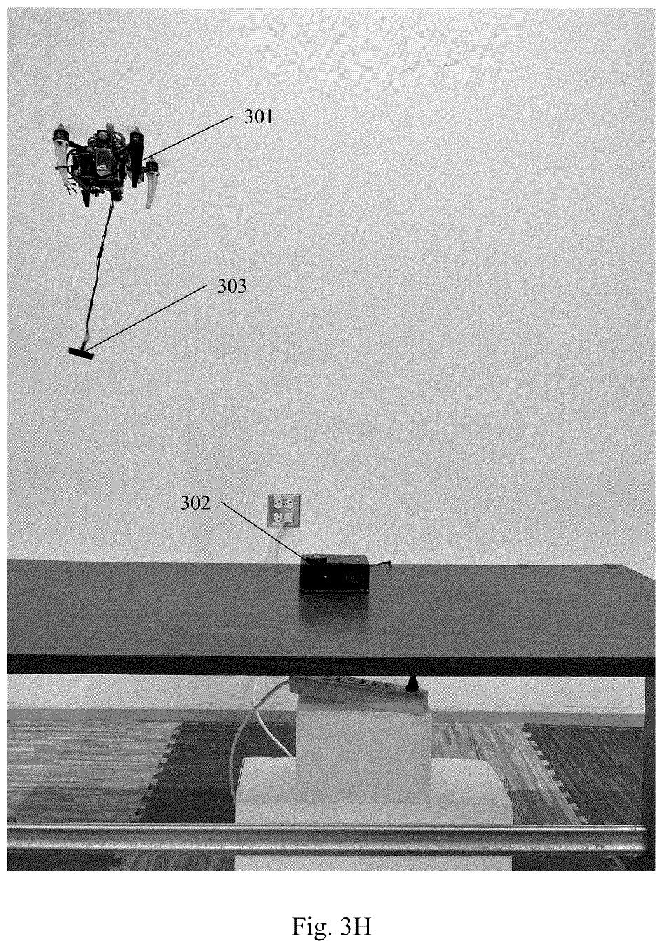

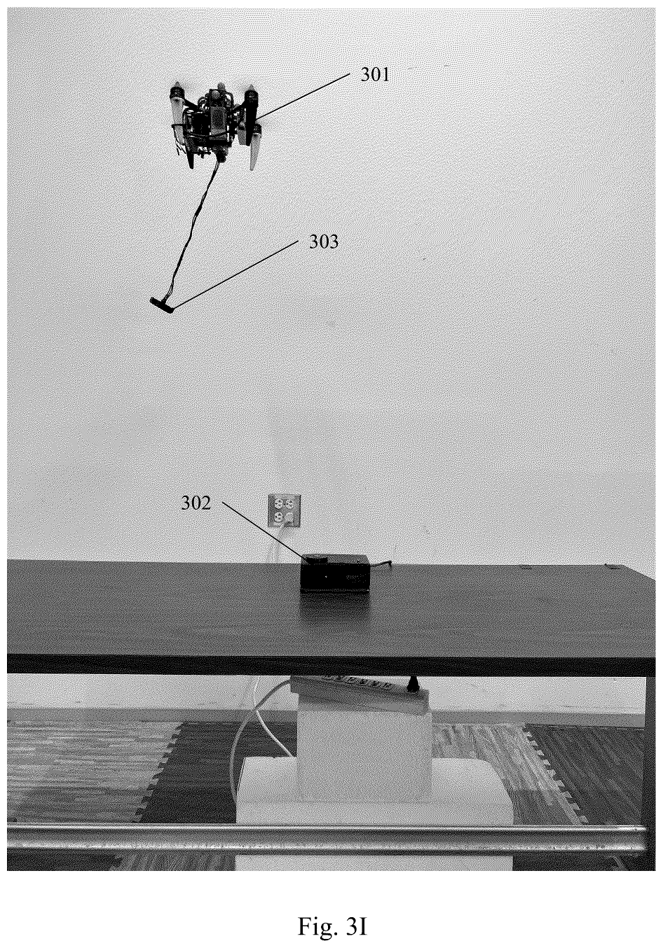

The disclosed system does not require any reserved area for the quadrotor's body to dock on, as illustrated in FIG. 3A—FIG. 3I. As a consequence, the ground station's dimensions are agnostic to the UAV's size and the station can be much smaller than the UAV, making the disclosed system highly portable. As discussed further below, the present disclosure provides a simple and precise description of the manufacturing process used to develop the disclosed ground station and charging tether. Some components are simple to manufacture from a low-cost (˜$300) 3D printer or milling machine, while others can be directly purchased off the shelf. Existing commercial solutions are remarkably expensive, reaching prices up to $30,000, while the disclosed system can be produced for less than $50.

### Discussion of Related Works

Battery expansion represents the simplest option available to increase a UAV's mission time. However, increasing the battery size does not linearly increment the flight time, as demonstrated Bauersfeld, et al., IEEE Robotics and Automation Letters, 2022. One of the core reasons is that expanding the battery capacity and size also inevitably increases the weight. Consequently, the motors need to provide more power for lifting and controlling the UAV, resulting in more energy being consumed.

Battery replacement represents an efficient solution because it provides the shortest recovery time for a UAV to return to flight and can be fully automated through external robotic systems. However, battery replacement solutions generally include highly-engineered bulky systems that are specifically designed for particular robot structures (see e.g. De Silva, et al., Drones, 2022; Williams, et al., International Conference on Control, Automation and Robotics, 2018; and Ure, et al., IEEE/ASME Transactions on Mechatronics, 2015). Moreover, these systems require periodical calibration or feedback control to ensure they remain in phase, hence they are especially prone to jamming.

For example, Michini, et al., Proceedings of the Infotech Aerospace, 2011 proposes a dual-drum structure that holds several batteries and automatically swaps the onboard battery with a charged one. Despite being an efficient solution for extending the flight time of quadrotors, the entire system structure is bulky and composed of a tremendous number of components, from microcontrollers and control motors to locking arms and rotational encoders. Therefore, the system is not portable and each of these several components introduce failure points that may damage the UAV and critically interrupt the performed mission.

Lee, et al., International Conference on Unmanned Aircraft Systems (ICUAS), 2015 attempts to simplify the system structure by using fundamental design principles but still does not resolve the problem of failure points during the battery replacement operation. Contrarily, the disclosed system is compact, lightweight, and configured to autonomously charge quadrotors that differ in size and battery capacity. Another major issue for battery replacement strategies is the need to precisely land on the docking station (see Liu, et al., IEEE Conference on Robotics, Automation and Mechatronics, 2017). While additional mechanical components can be designed to minimize this problem, this would introduce more complexity and failure points. In contrast, the disclosed system fully leverages electromagnetic induction to enable precise docking and un-docking, resulting in minimal moving components and thus guaranteeing high robustness to mechanical failures.

Finally, battery replacement methods require power cycling the UAV, which may have undesirable consequences for performance. The software stack may need to completely reset, and this may cause localization and control degradation once the robot is powered back on. Advantageously over battery replacement, autonomous charging allows the UAV to continuously sense the environment which may in some embodiments be key for mission success. In conclusion, battery replacement solutions are not universal, robust, or portable.

Wireless charging provides a straightforward charging operation that typically only requires the inclusion of a receiver coil on the UAV frame and supplying a corresponding wireless charging station with a transmitter coil. When the coils are close to one another, the onboard battery begins to charge. For example, Junaid, et al., Aerospace Science and Technology, 2016 presents a charging station using wireless inductive charging, the same technology used for charging smartphones and other electronic devices. However, the power transfer efficiency of wireless charging is only about 75% when the receiver and transmitter coils are precisely aligned and it significantly degrades as alignment decreases. Achieving precise alignment also requires a very precise landing or a very large receiver coil on the vehicle.

Several works have sought to address the issues of alignment and poor power transfer efficiency, for example, Chae, et al., 2015 IEEE International Conference on Advanced Intelligent Mechatronics (AIM), 2015.

In another example, the authors in Choi, et al., International Conference on Control, Automation and Information Sciences, 2016 designed a wireless charging station that uses ultrasonic sensors for identifying the UAV's position after landing. Stepper motors were configured to move the transmitter coil under the quadrotor. As with battery replacement systems, this solution employs multiple mechanical components to coordinate and precisely move, resulting in additional failure points. Additionally, despite advances in state estimation and mechanical systems for the alignment of the coils, even when such coils are accurately aligned, wireless charging efficiency remains 25-30% lower compared to tethered charging solutions, including the systems disclosed herein. As a result, wireless charging solutions are neither robust, nor efficient.

Contact charging provides high-efficiency charging by modifying a component of a UAV, for example the landing gear, to accommodate connectors that establish electrical contact between the vehicle and the charging station after docking (see e.g. Mulgaonkar, et al., 2014). For example, Song, et al., International Conference on Unmanned Aircraft Systems, 2014 proposes new landing gears to host the wires to charge the system as well as a charging station that consists of four metal plates. After landing, the quadrotor is switched off by a weight sensor on the station and the battery gets charged.

Cocchioni, et al., International Conference on Unmanned Aircraft Systems, 2014 presents similar landing gears with electrical connections from the battery to their lower ends and a passive centering system made of four upside-down hollow cones for correcting the landing positional error. Jain, et al., IEEE International Conference on Robotics and Automation (ICRA), 2020 shows a mid-air docking and in-flight battery charging approach. A small quadrotor carrying a fully charged battery docks on a bigger quadrotor in mid-air and charges the battery of the latter by using electrical connectors threaded in its landing gear.

Despite the appealing results, contact charging solutions require modification of specific quadrotor components for connecting the battery to the external power source, and are not easily generalizable to different robot structures. Moreover, these solutions require the quadrotor to land precisely in order to align the electrical connectors, thus creating control challenges, such as stochastic ground effects or disturbances during docking (see Saviolo, et al., arXiv, 2022; Mao, et al., IEEE Transactions on Robotics, 2023). Consequently, contact charging solutions are not universal, robust, or portable.

Tethered charging enables unlimited flight time by directly and physically connecting the quadrotor to a charging station. Hence, this strategy does not need precise physical landing and positioning on a charging station and avoids repeated recharging. Gu, et al., Nuclear Engineering and Technology, 2016, for example, employs tethered charging with a quadrotor for a mission in a nuclear power plant. The major drawback of tethered charging is the flight area that the quadrotor can cover. The charging tether used cannot be too long due to the internal resistance and weight of the cable itself which would reduce power efficiency and maneuverability respectively.

Several works have been proposed to overcome this limitation by enabling the ground station to move with the quadrotor. For example, Kiribayashi, et al., IEEE International Symposium on Safety, Security, and Rescue Robotics, 2015 uses an unmanned ground vehicle to carry the ground station that is directly connected to the quadrotor. The vehicle follows the quadrotor and extends the flight area. However, by combining aerial and ground vehicles, the quadrotor's maneuverability becomes limited by the ground conditions below it. As a result, tethered charging solutions are not portable.

The authors in Wang, et al., IEEE International Conference on Robotics and Automation (ICRA), 2021 propose a charging system that uses onboard sensing to attach a tether with a pair of loose hooks mid-flight. However, this method is not orientation-agnostic because the pair of hooks must match the charging station's polarity, requires precise control to localize and grasp the tether, and the loose tether attachment limits the quadrotor's ability to roll and pitch to avoid detachment.

The disclosed charging system is easy to assemble even by non-experts. For the sake of clarity and to simplify the design, components of the disclosed system were manufactured for charging up to 4-cell Lithium Polymer (LiPo) batteries. However, the same manufacturing process can be extended to LiPo batteries of larger capacities by including more copper rings in the connectors.

The disclosed device's operating principle is illustrated in FIG. 3A through FIG. 3I. When an onboard battery is running low, the quadrotor 301 approaches the charging station 302 and the natural magnetic force generated by the EM precisely auto-aligns the connector 303 with a mating connector on the charging station 302. Once the electrical connection is established, the EM is deactivated, the charging operation begins, and the quadrotor 301 lands (see FIG. 3E). During charging, the quadrotor's software stack remains active and no power cycling occurs. This guarantees that while refueling the quadrotor can perform multiple secondary mission tasks (see Mao, et al., IEEE Transactions on Robotics, 2023; Morando, et al., Drones, 2022; Morando, et al., IEEE International Conference on Robot and Human Interactive Communication, 2020). When the charging operation is completed, the quadrotor 301 smoothly un-docks from the ground station 302 and continues the mission (see FIG. 3H).

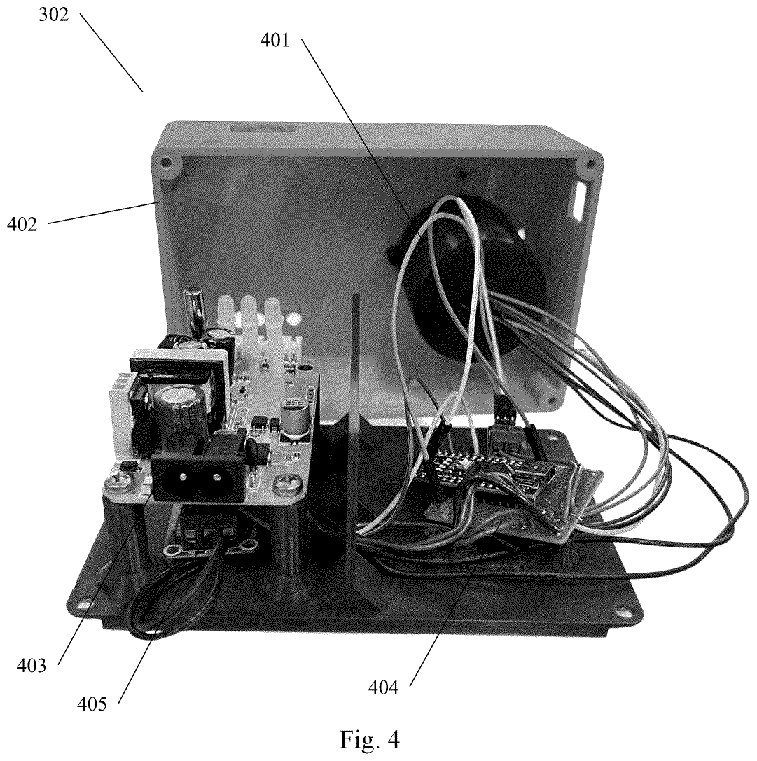

The ground station 302 (see FIG. 4) is designed to enable efficient charging once the electrical connection with the charging tether is established. The station may be mounted to the ground and is attached to an external power source. Components of the station are an electrical circuit (described in further detail below) an EM 401, a female circular magnetic connector (not shown), and an enclosure 402, which may in some embodiments comprise a polymer, for example poly-lactic acid (PLA). The ground station 302 further includes power conversion circuitry 403, for example comprising a balance charger; a switching device 405, which may for example comprise a relay. The ground station 302 may further comprise a microcontroller 404 or other computing device, for example configured to control the EM 401, the power conversion circuitry 403, and/or the relay 405. In some embodiments, the ground station 302 may comprise one or more indicator devices, for example a speaker for providing audio indications, one or more LEDs or controllable displays for providing visual information about the status of the ground station 302.

The EM 401 may be configured to selectively generate a powerful magnetic field that attracts the magnetic head of the charging tether when the quadrotor is approaching the station. The magnetic force may then be switched off, for example by the computing device 404, during charging and un-docking. This design ensures a fast, robust docking procedure along with smooth un-docking. The ground station may in some embodiments be designed to be flexible and adapt to different flight operations, leading to trade-offs between portability and robustness.

For example, if a mission is carried out in an outdoor environment characterized by stochastic wind effects that degrade the control and localization performance, then it may be advantageous to strengthen the magnetic field generated by the EM 401. Contrarily, if the flight mission is performed indoor with relatively accurate state estimation and control algorithms, then portability can be maximized by employing a smaller-scale EM 401. In some embodiments, the strength of the magnetic field generated by the EM 401 may be modulated, for example by computing device 404. In one embodiment, the strength of the magnetic field may be modulated by providing different power output to the EM 401 in different conditions.

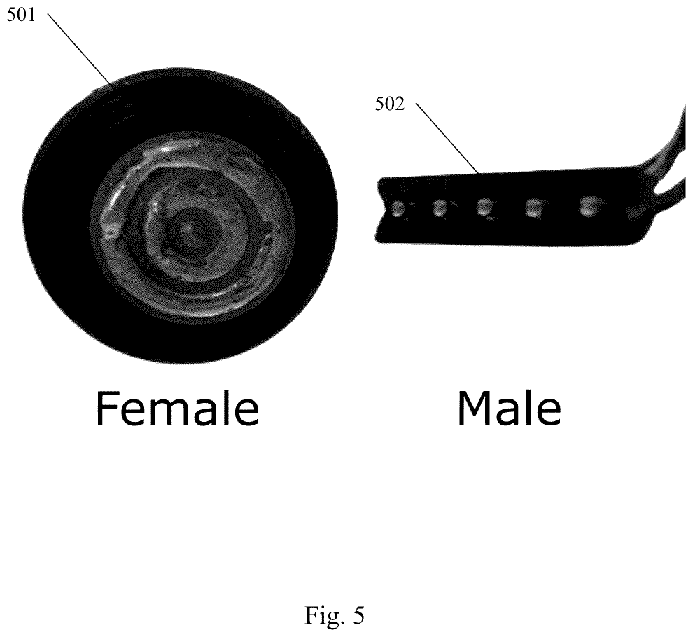

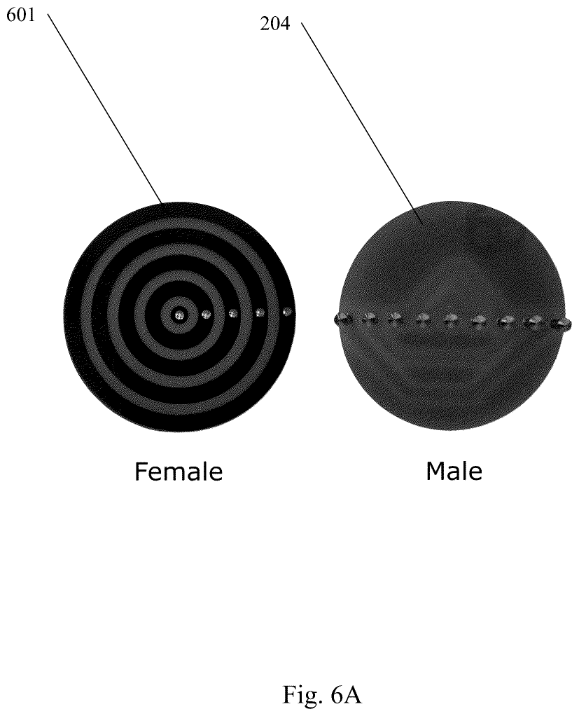

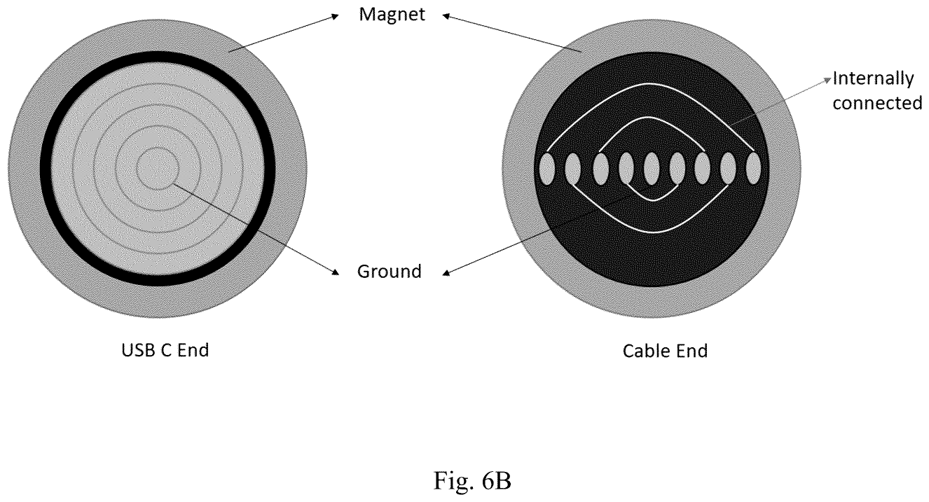

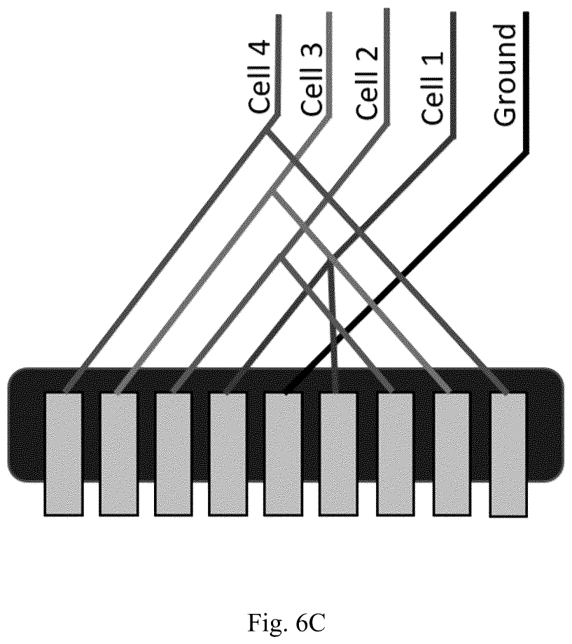

The female circular magnetic connector (see FIG. 5 and FIG. 6A) may be manufactured via any suitable method, including but not limited to using a mm-level precision printed circuit board (PCB) mill. An exemplary schematic diagram of male and female connectors is shown in FIG. 6B and FIG. 6C. One or more holes may be added to the female connector to allow electric connection from the back. The ground station enclosure 402 and fasteners, which are used for aligning and holding the female connector and other electronic components, may be produced via additive manufacturing or any other suitable means. The components may be connected to one another to form the ground station shown in FIG. 4. In some embodiments, the ground station 400 weighs 0.56 kg. and has the dimensions 15×10×6 cm³.

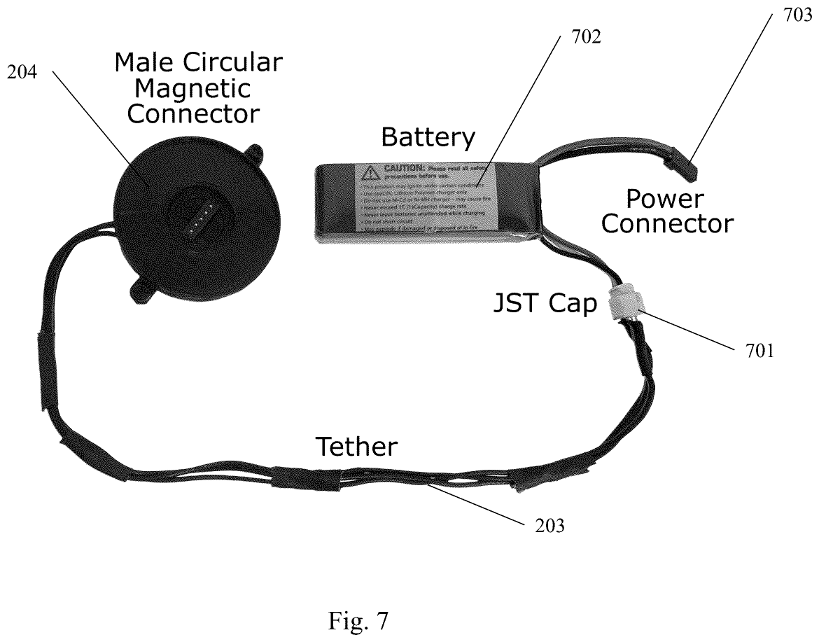

The charging tether 203 (see FIG. 7) is a custom cable that is connected to the battery 702, which in some embodiments (as seen in FIG. 2) dangles from the aircraft frame during flight operation. The tether may in some embodiments comprise low-resistance 20 gauge multi-core wire that connects a connector 701 to a circular magnetic connector 204. In some embodiments, the connector 701 may be a male or female connector configured to mate with a corresponding connector on battery 702. In some embodiments, the connector 701 may comprise a Japan Solderless Terminal (JST) connector.

The male circular magnetic connector 204 may comprise a line of contacts, for example pogo pins, which may in some embodiments be magnetic, and which matches the female circular connector 601 on the ground station (see for example FIG. 6A). The male connector 204 may in some embodiments be slightly concave or slightly convex, for example in order to ensures that while docking the electrical connection is established only when the male and female circuits perfectly mate, thus avoiding potential dangerous shorting issues.

The charging tether's length is arbitrary and should be chosen based on the carried flight task. If during charging the aircraft is passively waiting for the operation to be completed, then the tether's length may be short to minimize the effect on the dynamics of the system and minimize efficiency loss from increased resistance from a longer tether. Contrarily, if the aircraft is required to perform active tasks during charging, such as inspection or surveillance, then the tether's length can be relatively long.

Additional information on tethered flight and the tradeoffs related to a the tether's length and how the cable's resistance affects the charging efficiency may be found in Kiribayashi, et al., IEEE International Symposium on Safety, Security, and Rescue Robotics, 2015; Vishnevsky, et al., International Conference on Distributed Computer and Communication Networks, 2019; and Jain, et al., arXiv, 2022, all of which are incorporated herein by reference. The charging tether's weight is mainly determined by the weight of the magnetic connector. The magnetic strength of this connector can be fully customized for the considered application. Hence, trading-off portability and robustness is analogous to the EM design choice. This trade-off is explored in more detail in the experimental examples below.

In some embodiments, the disclosed tether comprises of 20 gauge multi-core wires which connect the battery connector to the ground station. The battery connector may comprise any suitable connector, and in some embodiments is a JST connector electrically connected to one end of the wires, for example via soldering. The tether is in some embodiments connected at the other end to the male circular magnetic connector that establishes the electrical connection with the ground station, as discussed above. Although the disclosed device comprises a male connector on the tether and a female connector on the ground station, it is understood that in some embodiments the female connector may be positioned on the tether and the male connector may be positioned on the ground station.

The connector may comprise a circular magnet and a set of contacts, for example pogo pins. The enclosure may be configured to contain both the electromagnet and pogo pins and secure them in place.

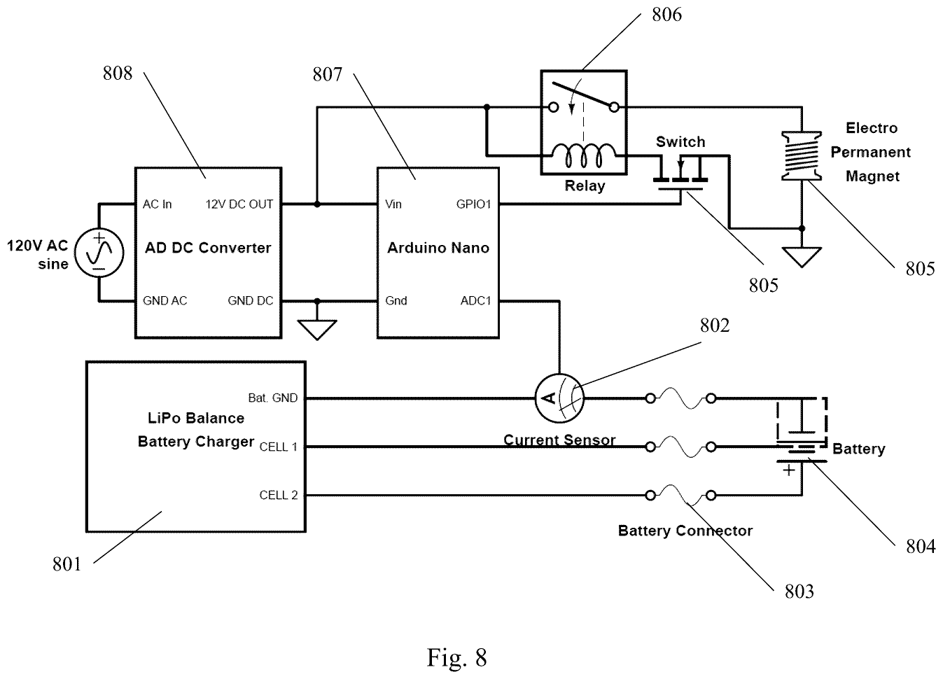

One embodiment of a circuit diagram of a disclosed charging system is shown in FIG. 8. The disclosed circuit diagram comprises a balance charger 801 and an EM control circuitry, including a current sensor 802. The balance charger 801 is directly connected to the female magnetic circular connector 803 which mates with the battery 804. The depicted system automatically detects and supplies power to one or more battery cells, hence providing a universal, efficient, and balanced charging operation for any suitable battery. Although the disclosed example was implemented with four cells, it is understood that the number of cells can be scaled up arbitrarily.

The EM 805 is controlled through an Arduino Nano microcontroller 807, and selectively powered from an AC-DC converter 808, which connects the disclosed device to an AC power source. A relay 806 is arranged to allow the microcontroller 807 to turn power to the EM on or off. Some embodiments may further comprise a switch 805 allowing for manual control of the EM 805. In some embodiments, in idle conditions, for example while the aircraft is not attached, the relay 806 closes and the current flows allowing the EM 805 to pull the tether into position when it comes within range of the EM's magnetic field.

The microcontroller 807 may then detect battery attachment for example by measuring the amount of current flowing through the battery connector 803, and then may switch the relay 806 open, shutting down the EM. The aircraft may in some embodiments be configured to measure its internal battery voltage to estimate its current capacity and take off autonomously once a sufficient amount of charge has been accumulated. After the aircraft takes off, no current flows through the connector 803 or the current sensor 802, and the relay 806 then closes after a short delay allowing another charging iteration to occur.

In some embodiments, one or more other sensors may be used to detect vehicle attachment, for example a proximity sensor positioned near the connector, a load cell to measure weight on the connector, one or more optical sensors, or the like. In some embodiments, vehicle attachment status may be detected by a sensor positioned on the aircraft, and relayed to the ground station via any suitable wired or wireless communication method, for example Bluetooth.

The disclosed control system provides the benefit of robust docking from high magnetic fields and also easy detachment when charging is complete. In some embodiments, an additional wireless communication device can be implemented to remotely control the EM for greater control.

### EXPERIMENTAL EXAMPLES

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

Without further description, it is believed that one of ordinary skill in the art can, using the preceding description and the following illustrative examples, make and utilize the system and method of the present invention. The following working examples therefore, specifically point out the exemplary embodiments of the present invention, and are not to be construed as limiting in any way the remainder of the disclosure.

The robustness of the disclosed device was validated by running multiple experiments in both indoor and outdoor environments. The indoor flying arena used for the indoor experiments was equipped with a Vicon motion capture system which provided accurate state estimates at 100 Hz. For outdoor flights, a visual-inertial odometry algorithm combined with IMU measurements with an unscented kalman filter provided state estimates at 500 Hz and controlled using a nonlinear controller based on Loianno, et al., IEEE Robotics and Automation Letters, 2016.

Trajectories were planned using trapezoidal velocity profiles. Different design choices of the disclosed system were compared the trade-off between portability and robustness was evaluated, with the results discussed in the examples below. Specifically, the aircraft's default configuration (Del) was altered with three charging tethers of length 0.5 m with different male magnetic connectors: a small neodymium magnet of weight 0.42 g and pulling force 771.11 g (NeodS), a medium ceramic magnet of weight 17.5 g and pulling force 2721.55 g (CeraM), and a large ceramic magnet of weight 34.7 g and pulling force 4989.52 g (CeraL).

The universality of the disclosed system was demonstrated by using two aircraft of different frame sizes, battery capacities, and thrust-to-weight ratios for conducting the experiments. The first aircraft (referred to herein as SD2S) was equipped with a Qualcomm® Snapdragon™ board and four brushless motors and weighed 250 g including the battery. SD2S was powered by a 2-Cell/2S battery with a capacity of 910 mAh that weighed 47 g and had a maximum voltage of 7.4 V.

The second aircraft (referred to herein as NX4S) was equipped with an Nvidia® Jetson™ NX board and four brushless motors, and weighed 890 g including the battery. The second aircraft was equipped with a 4-Cell/4S battery with a capacity of 3000 mAh that weighted 281 g and had a maximum voltage of 14.8 V.

### Results

The evaluation procedure was designed to address the following questions: (i) What is the impact of the charging tether's weight for different choices of magnet on docking success, power consumption, and control performance? (ii) Can the disclosed system be employed to autonomously charge aircraft with various frame shapes and battery capacities? (iii) Does the proposed system enable perpetual autonomous charging in a long flight mission?

### Portability Vs Robustness

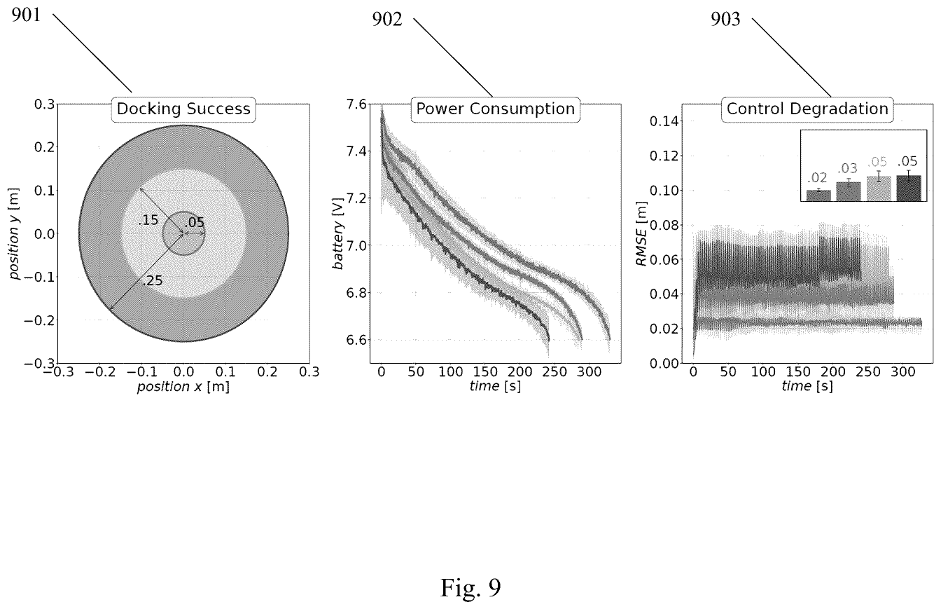

Different magnetic connectors were investigated for their effects on the docking success, power consumption, and control degradation of the SD2S aircraft. First, the docking success was evaluated in terms of the maximum distance from which the ground station is able to pull the male magnetic connector into a correct position using the EM. Also, the power consumed and the control degradation resulting from different tether configurations was evaluated during an effort to continuously track a circular trajectory of radius 1 m at 2 m/s until the battery voltage reached 6.6 V. A graph of the results of the docking success experiment is shown in graph 901 of FIG. 9.

The control degradation was evaluated based on the root mean squared error (RMSE) between the quadrotor position and reference trajectory at every control iteration, and the power consumption was measured in terms of battery voltage over time. The experiments were repeated 5 times to estimate the mean and standard deviation of both metrics. For each experiment, the aircraft's mass was scaled appropriately for the controller, and the ground station's EM and magnetic attractiveness remained constant. A graph of the results of the control degradation experiment is shown in graph 903 of FIG. 9.

The additional weight increased the amount of thrust that the motors needed to provide for lifting and controlling the aircraft. Consequently, the flight time for heavier magnetic connectors was inferior to smaller ones, resulting in a flight time degradation of up to 15%. (see graph 902 of FIG. 9). Moreover, the results show that altering the aircraft's system with the lighter charging tether does not significantly affect the tracking performance. Therefore, this demonstrates that the proposed charging solution does not significantly alter the aircraft's system dynamics. Importantly, the results show that employing larger and stronger magnets directly impacts the docking success, by improving the pull distance by a factor of five. This boosted docking performance may be critical for applications where localization and control errors are unavoidable (e.g., outdoor environments affected by stochastic wind gusts), enabling the aircraft to reliably perform precise docking operations. When the male circular magnetic connector is within the bounds of the docking success area, the attachment operation had a 100% success rate in all the performed experiments. The performance was further validated by controlling an aircraft to continuously attach and detach from the ground station over 100 iterations.

### Universality

Universality is a desirable characteristic of any charging system. Every system should demonstrate the capability to autonomously charge different aircraft frame sizes and battery capacities. Therefore, the following example demonstrates the disclosed system's ability to autonomously charge the aircraft referred to as SD2S and NX4S (see above).

Specifically, the aircraft were controlled to repetitively perform the docking and un-docking operations to simulate the charging process during perpetual missions. FIG. 3A-FIG. 3I illustrate some snapshots of this experiment. The results show that the docking and un-docking performance is solidly repeatable while using the same connectors for different quadrotors with 2S and 4S batteries, hence validating the disclosed system as a universal charging solution.

Perpetual Quadrotor Flight

Demonstrated below is the ability and flight time benefits of employing the disclosed system on a long perpetual flight test. Specifically, the SD2S aircraft was used to track multiple trajectories until the battery voltage reached 6.6 V. Then, the aircraft was required to reach the ground station, dock, and recharge. After charging was complete, the quadrotor detached from the ground station and continued tracking the random trajectories. The experiment ended after 10 hours.

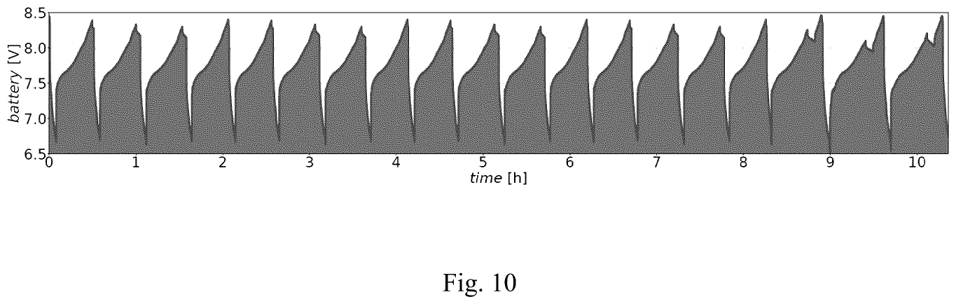

FIG. 10 illustrates how the battery voltage changed over time during the entire experiment. The aircraft consistently and robustly docked, charged, and un-docked for long periods without any human intervention. Moreover, the results showed no noticeable battery degradation over the entire flight, hence validating the disclosed system for safe and efficient charging for quadrotors. Toward the end of the 10 hour flight, the charger's temperature protection was triggered causing it to throttle the charging current until the ideal operating temperature range was reached. Successively, the charging operation was resumed and the battery was charged until completion. This behavior created short voltage dips that characterize the last voltage peaks as shown in FIG. 10.

### Discussion

Autonomous charging has the potential to staggeringly empower future applications for battery-powered aircraft, in such applications as expanding the range of delivery systems, persistently inspecting large crop fields to identify pests, and acting as a mobile communication hub during disaster management. Commercial solutions available do not satisfy the requirements of the ideal autonomous charging solution and are terribly expensive.

Disclosed herein is an autonomous charging system for battery-powered aircraft that is capable of universal, highly efficient, and robust charging. These capabilities were validated in several experiments where the disclosed system demonstrated high flexibility to different aircraft, battery capacities, system dynamics, and task objectives.

Moreover, the system was stress tested for over 10 hours to validate its charging repeatability. The disclosed system offers a highly-flexible charging solution that can be customized to the considered application. Specifically, larger stations can be deployed in some embodiments, employing stronger magnets, allowing less accurate control to dock with the station. This magnet force increase comes at the cost of less portable stations and more external forces on the vehicle.

In some embodiments, some of these issues are overcome via an admittance controller to accommodate large magnetic forces (see Ott, et al., IFAC Proceedings Volumes, 2009) creating a smooth transition for the quadrotor during the docking maneuver.

In some embodiments, the usability of the disclosed charging solution may be increased without prior knowledge of the location of the ground station, for example by using cameras to visually localize the aircraft and control the aircraft in an image-based visual servoing fashion (see Thomas, et al., IEEE International Conference on Robotics and Automation (ICRA), 2014).

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

### REFERENCES

The following publications are incorporated herein by reference in their entirety:
B. J. Emran and H. Najjaran, “A review of quadrotor: An underactuated mechanical system,” Annual Reviews in Control, vol. 46, pp. 165-180, 2018.
S. C. De Silva, M. Phlernjai, S. Rianmora, and P. Ratsamee, “Inverted docking station: A conceptual design for a battery-swapping platform for quadrotor uays,” Drones, vol. 6, no. 3, 2022.
A. Williams and O. Yakimenko, “Persistent mobile aerial surveillance platform using intelligent battery health management and drone swapping,” in International Conference on Control, Automation and Robotics, 2018, pp. 237-246.
Z.-n. Liu, Z.-h. Wang, D. Leo, X.-Q. Liu, and H.-w. Zhao, “Quado: An autonomous recharge system for quadcopter,” in IEEE Conference on Robotics, Automation and Mechatronics, 2017, pp. 7-12.
N. K. Ure, G. Chowdhary, T. Toksoz, J. P. How, M. A. Vavrina, and J. Vian, “An automated battery management system to enable persistent missions with multiple aerial vehicles,” IEEE/ASME Transactions on Mechatronics, vol. 20, no. 1, pp. 275-286, 2015.
D. Lee, J. Zhou, and W. T. Lin, “Autonomous battery swapping system for quadcopter,” in International Conference on Unmanned Aircraft Systems (ICUAS), 2015, pp. 118-124.
B. Michini, T. Toksoz, J. Redding, M. Michini, J. How, M. Vavrina, and J. Vian, “Automated battery swap and recharge to enable persistent uav missions,” Proceedings of the Infotech Aerospace, 2011.
A. M. Jawad, R. Nordin, H. M. Jawad, S. K. Gharghan, A. Abu-Samah, M. J. Abu-Alshaeer, and N. F. Abdullah, “Wireless drone charging station using class-e power amplifier in vertical alignment and lateral misalignment conditions,” Energies, vol. 15, no. 4, 2022.
A. B. Junaid, Y. Lee, and Y. Kim, “Design and implementation of autonomous wireless charging station for rotary-wing uays,” Aerospace Science and Technology, vol. 54, pp. 253-266, 2016.
C. H. Choi, H. J. Jang, S. G. Lim, H. C. Lim, S. H. Cho, and I. Gaponov, “Automatic wireless drone charging station creating essential environment for continuous drone operation,” International Conference on Control, Automation and Information Sciences, pp. 132-136, 2016.
H. Chae, J. Park, H. Song, Y. Kim, and H. Jeong, “The iot based automate landing system of a drone for the round-the-clock surveillance solution,” in 2015 IEEE International Conference on Advanced Intelligent Mechatronics (AIM), 2015, pp. 1575-1580.
K. P. Jain and M. W. Mueller, “Flying batteries: In-flight battery switching to increase multirotor flight time,” in IEEE International Conference on Robotics and Automation (ICRA), 2020, pp. 3510-3516.
F. Cocchioni, A. Mancini, and S. Longhi, “Autonomous navigation, landing and recharge of a quadrotor using artificial vision,” International Conference on Unmanned Aircraft Systems, pp. 418-429, 2014.
Y. Mulgaonkar and V. Kumar, “Autonomous charging to enable longendurance missions for small aerial robots,” 06 2014, p. 90831S.
B. D. Song, J. Kim, J. Kim, H. Park, J. R. Morrison, and D. H. Shim, “Persistent uav service: An improved scheduling formulation and prototypes of system components,” International Conference on Unmanned Aircraft Systems, 2014.
B. W. Gu, S. Y. Choi, Y. S. Choi, G. Cai, L. Seneviratne, and C. T. Rim, “Novel roaming and stationary tethered aerial robots for continuous mobile missions in nuclear power plants,” Nuclear Engineering and Technology, vol. 48, no. 4, pp. 982-996, 2016.
S. Kiribayashi, J. Ashizawa, and K. Nagatani, “Modeling and design of tether powered multicopter,” in IEEE International Symposium on Safety, Security, and Rescue Robotics, 2015, pp. 1-7.
Y. Wang, Q. Sun, T. Berger, and W. Qi, “A drive-through recharging strategy for a quadrotor,” in IEEE International Conference on Robotics and Automation (ICRA), 2021, pp. 420-425.
L. Bauersfeld and D. Scaramuzza, “Range, endurance, and optimal speed estimates for multicopters,” IEEE Robotics and Automation Letters, vol. 7, no. 2, pp. 2953-2960, 2022.
A. Saviolo, G. Li, and G. Loianno, “Physics-inspired temporal learning of quadrotor dynamics for accurate model predictive trajectory tracking,” IEEE Robotics and Automation Letters, 2022.
A. Saviolo, J. Frey, A. Rathod, M. Diehl, and G. Loianno, “Active learning of discrete-time dynamics for uncertainty-aware model predictive control,” arXiv preprint arXiv:2210.12583, 2022.
J. Mao, S. Nogar, C. M. Kroninger, and G. Loianno, “Robust active visual perching with quadrotors on inclined surfaces,” IEEE Transactions on Robotics, pp. 1-17, 2023.
L. Morando, C. T. Recchiuto, J. Calla, P. Scuteri, and A. Sgorbissa, “Thermal and visual tracking of photovoltaic plants for autonomous uav inspection,” Drones, vol. 6, no. 11, 2022.
L. Morando, C. T. Recchiuto, and A. Sgorbissa, “Social drone sharing to increase the uav patrolling autonomy in emergency scenarios,” in IEEE International Conference on Robot and Human Interactive Communication, 2020, pp. 539-546.
V. M. Vishnevsky, B. Tereschenko, D. A. Tumchenok, A. M. Shirvanyan, and A. Sokolov, “Principles of building a power transmission system for tethered unmanned telecommunication platforms,” in International Conference on Distributed Computer and Communication Networks. Springer, 2019, pp. 94-110.
K. P. Jain, P. Kotaru, M. d. Sa, M. W. Mueller, and K. Sreenath, “Tethered power supply for quadcopters: Architecture, analysis and experiments,” arXiv preprint arXiv:2203.08180, 2022.
G. Loianno, C. Brunner, G. McGrath, and V. Kumar, “Estimation, control, and planning for aggressive flight with a small quadrotor with a single camera and imu,” IEEE Robotics and Automation Letters, vol. 2, no. 2, pp. 404-411, 2016.
S. D. Technology”, “Dji dock,” 2022. [Online]. Available: https://www.dji.com/dock
“Hextronics”, “Hextronics global advanced,” 2022. [Online]. Available: https://www.hextronics.tech/global
“IDIPLOYER”, “Idiployer nexus,” 2022. [Online]. Available: https://flytnow.com/idiployer
“Skycharge”, “Skycharge skyport dp5,” 2022. [Online]. Available:https://www.skycharge.de/charging-system
G. Li, A. Tunchez, and G. Loianno, “PCMPC: Perception-constrained model predictive control for quadrotors with suspended loads using a single camera and IMU,” in IEEE International Conference on Robotics and Automation (ICRA), 2020.
C. Ott and Y. Nakamura, “Admittance control using a base force/torque sensor,” IFAC Proceedings Volumes, vol. 42, no. 16, pp. 467-472, 2009.
J. Thomas, G. Loianno, K. Sreenath, and V. Kumar, “Toward image based visual servoing for aerial grasping and perching,” in IEEE International Conference on Robotics and Automation (ICRA), 2014, pp. 2113-2118.

What is claimed is:

1. A system for charging a battery in an aircraft, comprising: a ground station comprising:
an electrical connector configured to be connected to a source of power;
a charging port comprising a plurality of electrical contacts positioned on a surface of the ground station; and
at least one ground station magnetic element positioned on the surface of the ground station;
a tether having a proximal and distal end, configured to be connected at the proximal end to the aircraft, comprising:
an electrical connector at the proximal end configured to be connected to a battery of a aircraft;
at least one tether magnetic element positioned at the distal end; and
a tether charging connector positioned at the distal end, configured to electrically connect to the charging port when the at least one tether magnetic element is connected to the at least one ground station magnetic element.

2. The system of claim 1, wherein the charging port comprises a central conductive element and at least one circular conductive element concentric with the central conductive element.

3. The system of claim 2, wherein the at least one circular conductive element comprises two circular conductive elements.

4. The system of claim 1, wherein the tether charging connector comprises a plurality of conductive elements arranged in a linear array.

5. The system of claim 4, wherein, the charging port comprises a central conductive element and K circular conductive elements concentric with the central conductive element; and
wherein the tether charging connector comprises a plurality of 2K+1 conductive elements arranged in a linear array.

6. The system of claim 4, wherein the plurality of conductive elements comprise pogo pins.

7. The system of claim 1, wherein the tether comprises 20 gauge multi-core wire.

8. The system of claim 1, wherein the battery of the aircraft is selected from a lithium ion battery or a lithium polymer battery.

9. The system of claim 1, further comprising a current sensor configured to detect a current passing through the charging port.

10. The system of claim 1, wherein the ground station magnetic element comprises an electromagnet, and wherein the ground station further comprises a relay configured to enable or disable the electromagnet.

11. The system of claim 1, further comprising a computing device electrically connected to the ground station, configured to control the electromagnet.

12. A method of charging an aircraft, comprising:
providing an aircraft having a charging tether with a tether electrical connector comprising a tether magnetic element;
providing a charging station having a charging port configured to mate with the tether electrical connector and a controllable magnetic element;
moving the aircraft into a position such that the tether electrical connector is proximate to the charging port;
engaging the controllable magnetic element to attract the tether magnetic element of the tether electrical connector toward the charging port; and
when the tether electrical connector is electrically connected to the charging port, disengaging the controllable magnetic element.

13. The method of claim 12, further comprising the step of landing and powering down the aircraft after the tether electrical connector is electrically connected to the charging port.

14. The method of claim 12, further comprising the step of, when a battery of the aircraft is fully charged, moving the aircraft away from the charging station, causing the tether electrical connector to disengage from the charging port.

15. The method of claim 12, further comprising the step of detecting when the tether electrical connector is electrically connected to the charging port with a sensor connected to a computing device, and disengaging the controllable magnetic element with the computing device.

16. The method of claim 15, wherein the controllable magnetic element is disengaged via a relay.

17. The method of claim 15, wherein the sensor is a current sensor.

18. The method of claim 15, wherein the sensor is a proximity sensor.
